(19) United States
(12) Patent Application Publication
(10) Pub. No.: US 2007/0220048 A1
(43) Pub. Date: Sep. 20, 2007

(54) Limited and combined podcast subscriptions

(75) Inventor: Edward Stanley Ott IV, Palo Alto, CA (US)

Correspondence Address: James J. DeCarlo;GREENBERG TRAURIG, LLP, MetLife Building, 200 Park Avenue, New York, NY, 10166, US

(73) Assignee: Yahoo! Inc., Sunnyvale, CA (US)

(21) Appl. No.: 11/385,489

(22) Filed: Mar. 20, 2006

(51) Int. Cl. G06F 7/00

(52) U.S. Cl. 707/104.1

(57) ABSTRACT

The present invention relates to a computerized system and method for managing subscriptions to podcasts or other feeds so that the user obtains only selected episodes from only selected podcasts. In the system, a user selects one or more podcast feeds from those available and further selects one or more filter criteria. Then, as new episodes are added to the selected podcast feeds, the system compares the new episodes against the filter criteria. Episodes conforming to the filter criteria are then presented to the user while the user is not alerted to episodes that do not conform to the filter criteria. The system may create a derivative feed on a local or remote computing system to which is copied only the episode identification information that conforms to the filter criteria. The system can then have the user's device subscribe to derivative feed, thus requiring no change of the user's podcasting software.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

The expansion of the Internet and the World Wide Web (“web”) has given computer users the enhanced ability to listen to and to watch various different forms of media content through their computers. Such content can be in the form of audio music, music videos, television programs, sporting events or any other form of audio or video content that a user wishes to watch, read, listen to or otherwise perceive in some manner.

Multimedia data files, or media files, are data structures that may include audio, video or other content stored as data in accordance with a container format. A container format is a file format that can contain various types of data, possible compressed a standardized and known manner. The container format allows a rendering device to identify, and if necessary, interleave, the different data types for proper rendering. Some container formats can contain only audio data, while other container formation can support audio, video, subtitles, chapters and metadata along with synchronization information needed to play back the various data streams together. For example, an audio file format is a container format for storing audio data. There are many audio-only container formats including known in the art including WAV, AIFF, FLAC, WMA, and MP3. In addition, there are now a number of container formats for use with combined audio, video and other content including AVI, MOV, MPEG-2 TS, MP4, ASF, and RealMedia to name but a few.

Media files accessible over a network are increasingly being used to deliver content to mass audiences. For example, one emerging way of periodically delivering content to consumers is through podcasting.

Podcasting is a method of publishing digital media, typically audio programs, via the Internet, allowing users to subscribe to a series of new files (e.g., .MP3 audio files) as they become available over time. The word “podcasting” became popular in late 2004, largely due to automatic downloading of audio onto portable players or personal computers. Podcasting is distinct from other types of online media delivery because of its subscription model, which uses a “feed” (such as RSS, discussed below, and Atom) to monitor for and/or deliver a file. A feed in this context refers to an electronic means, such as a file containing a list of media files, that can be easily interpreted to identify new files in the list as the files are added over time. Thus, one is said to subscribe to a feed because as new files are added to the list, the subscriber is notified of the new file and, in some cases, the new file is automatically delivered to the subscriber.

Podcasting enables independent producers to create self-published, syndicated media, such as “radio shows,” and gives broadcast news, radio, and television programs a new distribution method. Listeners may subscribe to feeds using “podcatching” software (a type of aggregator), which periodically checks for and downloads new content automatically. Most podcatching software enables the user to copy podcasts to portable music players. Most digital audio player or computer with audio-playing software can play podcasts. From the earliest RSS-enclosure tests, feeds have been used to deliver video files as well as audio. By 2005 some aggregators and mobile devices could receive and play video, although the “podcast” name remains most associated with audio. Other names are sometimes used for casting other forms of media, such as blogcasting for text and vcasting or vodcasting for video. For the purposes of this application, podcast is used in its most general sense to refer to a feed of new files in any format (e.g., .MP3, .MPEG, .WAV, .JPG) and containing any content (e.g., text-based, audible, visual or some combination) that can be subscribed to. Also, for the purposes of this discussion an individual podcast feed may be alternately referred to as a series. Each distinct new file in a series or feed may be referred to as an individual episode of the series.

Podcasting is supported by underlying feed formats, of which RSS is but one example. RSS is a family of XML file formats for web syndication used by (among other things) news websites and weblogs. The abbreviation is alternately used to refer to the following recognized standards: Rich Site Summary (RSS 0.91); RDF Site Summary (RSS 0.9 and 1.0); and Really Simple Syndication (RSS 2.0).

Feed formats, such as the RSS formats, often allow the feed creator (referred to as the publisher) to include web content or summaries of web content together with links to the full versions of the content, and other meta-data. This information may be associated with different episodes of the feed, thus allowing an easy way to provide at least some summary information to the subscriber so that a subscriber does not have to render each episode to determine if it contains information of interest. This information may be delivered within an XML feed file, a webfeed, an RSS stream, or RSS channel.

The technology behind podcasting allows a client to subscribe to websites that have provided RSS feeds or feeds in other formats; these are typically sites that change or add content regularly. To use this technology the client needs some type of aggregation service or aggregator. The aggregator allows a client to subscribe to the podcasts that the client wants to monitor or to get updates (i.e. future media files in the feed) on. Unlike typical subscriptions to pulp-based newspapers and magazines, your RSS subscriptions are free, but they typically only provide a line or two of each article or post along with a link to the media file that contains the episode (e.g., the full text article, audio file or video file). In addition to facilitating syndication, a feed allows a website's frequent readers to track updates on the site using an aggregator.

Feeds, including RSS feeds, are widely used by the weblog community to share the latest episodes' headlines or their full text, and even attached multimedia files. In mid 2000, use of RSS for podcasting text spread to many major news organizations, including Reuters, CNN and the BBC, until under various usage agreements, providers allow other websites to incorporate their “syndicated” headline or headline-and-short-summary feeds. Feeds are now used for many purposes, including marketing, bug-reports, or any other activity involving periodic updates or publications.

A program known as a feed reader or aggregator can check feeds, such as RSS-enabled webpages, on behalf of a user and display any updated articles that it finds. It is now common to find RSS feeds on major web sites, as well as many smaller ones. Client-side readers and aggregators are typically constructed as standalone programs or extensions to existing programs like web browsers. Such programs are available for various operating systems.

Podcasting has become a very popular and accepted media delivery paradigm. This success has caused the number and variety of podcasts available to clients to grow exponentially. Potential podcast consumers are now confronted with the problems of how to find podcasts, how to organize and manage their podcast subscriptions; and how to listen to episodes efficiently and easily. Podcast publishers are also confronted with problems including how to effectively market their podcasts, how to generate income from their podcasts, how to easily create and disseminate podcasts, how to support different feed formats and device needs, and how to manage bandwidth and storage costs.

### SUMMARY OF THE INVENTION

The present invention relates to a system and method for managing subscriptions to podcasts so that the user obtains only selected episodes from only selected podcasts. In the system, a user selects one or more podcast feeds from those available and further selects one or more filter criteria. Then, as new episodes are added to the selected podcast feeds, the system compares the new episodes against the filter criteria. Episodes conforming to the filter criteria are then presented to the user while the user is not alerted to episodes that do not conform to the filter criteria. The system may create a derivative feed on a local or remote computing system to which is copied only the episode identification information that conforms to the filter criteria. The system can then have the user's device subscribe to derivative feed, thus requiring no change of the user's podcasting software.

In one example (which example is intended to be illustrative and not restrictive), the present invention may be considered a method for creating a customized subscription that contains only episodes of interest from one pre-existing feed (e.g., a limited subscription) or a group of selected feeds (e.g., a combined subscription). The method includes receiving a first request to create a customized subscription to selected episodes from at least one feed from a user and creating a customized subscription. The method further includes in response to second requests from the user to access the customized subscription, transmitting information identifying the selected episodes from the at least one feed to the user.

In another example (which example is intended to be illustrative and not restrictive), the present invention may be considered a method including receiving a selection of a plurality of first feeds from a user and a selection of at least one criterion from the user. The method also may include receiving a selection of a name to be associated with the plurality of first feeds and the at least one criterion from the user. As episodes conforming to the at least one criterion are added to the first feeds over time, the method alerts the user of the episodes of the plurality of first feeds that meet the at least one criterion, as the episode become available over a period of time. Alerting may be performed through a simple notification or may include downloading the new episodes automatically to the user's device.

In another example (which example is intended to be illustrative and not restrictive), the present invention may be considered a system for providing to a user only episodes of feeds of interest to the user. The system includes a subscription management system adapted to receive user selections of at least one feed and at least one filter criteria and further adapted to generate a customized subscription in response to the user selections. The system also includes at least one customized subscription created by the subscription management system in response to the user selections, the customized subscription when accessed by the user provides information concerning only the episodes of the at least one feed that conform to the at least one filter criteria.

In another example (which example is intended to be illustrative and not restrictive), the present invention may be considered a graphical user interface for creating a customized subscription. The graphical user interface (GUI) includes a first user-selectable interface element for selecting one or more root feeds and a second interface element for inputting at least one filter criterion for screening episodes of the root feeds. The GUI may further include a third interface element for inputting a name of the customized subscription and also a fourth interface element that, upon selection by a user, causes the customized subscription to be created.

Additional features of the invention will be set forth in the description which follows, and in part will be apparent from the description, or may be learned by practice of the invention. The benefits and features of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The following drawing figures, which form a part of this application, are illustrative of embodiments of the present invention and are not meant to limit the scope of the invention in any manner, which scope shall be based on the claims appended hereto.

FIG. 1 is a flowchart depicting an embodiment of a method for managing podcast subscriptions.

FIG. 2 is an illustration of an exemplified embodiment of an architecture for a syndication system;

FIG. 3 illustrates an embodiment of a method for subscribing only to episodes of interest to a user.

FIG. 4 illustrates another embodiment of a method for subscribing only to episodes of interest to a user.

FIG. 5 illustrates an embodiment of a graphical user interface of a subscription management system for creating a customized subscription.

FIG. 6 illustrates an embodiment of a graphical user interface through which a user may select feeds and filter criteria as part of creating a customized subscription.

### DETAILED DESCRIPTION OF PREFERRED EMBODIMENTS

In general, the specification discusses a system and method for managing subscriptions to podcasts so that the user is shown, or automatically receives, only selected episodes from only selected podcasts. In the system, a user selects one or more podcast feeds from those available and further selects one or more filter criteria. Then, as new episodes are added to the selected podcast feeds, the system compares the new episodes against the filter criteria. Episodes conforming to the filter criteria are then presented to the user while the user is not alerted to episodes that do not conform to the filter criteria. Thus, the user is, in effect, subscribed to only to those episodes that conform to the filter criteria.

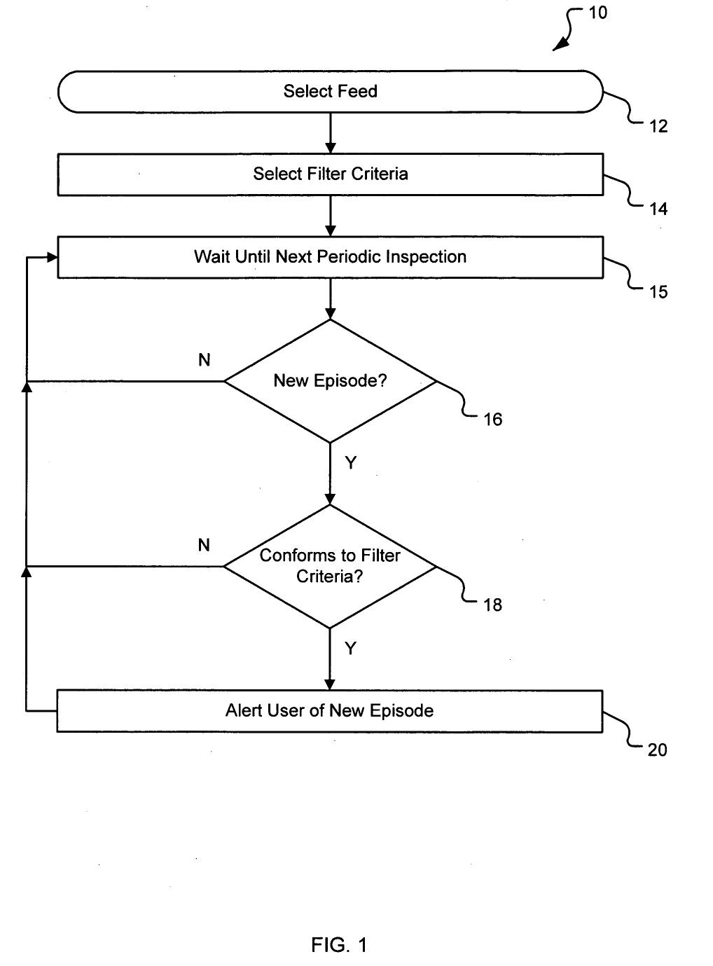

FIG. 1 is a flowchart depicting a high-level embodiment of a method for managing podcast subscriptions. In the embodiment 10, a user interacts with the system to select one or more podcast feeds, and transmit those selections to a subscription management system, in a feed selection operation 12. The user also selects one or more filter criteria in a criteria selection operation 14, which also includes transmitting those selections to a subscription management system. As time progresses and new episodes are added to the selected feeds, the subscription management system periodically inspects the selected feeds to identify new episodes. In the embodiment 10, this is illustrated by a waiting operation 15 in which the system is idle until the next inspection.

In a periodic or occasional inspection, the system accesses the selected feeds and compares the current version of the feed with information stored by the system to identify any new episodes that have been added since the last inspection in a new episode determination operation 16. If there is not a new episode, then the system waits for the next inspection in the wait operation 15. If there is a new episode, the system then compares the information known about the new episode with the filter criteria in a determination operation 18. If the new episode does not conform to the filter criteria, then no action is taken to alert the user of the new episode and the system waits for the next inspection in the wait operation 15. If the new episode does conform to the filter criteria, then the user is alerted to the existence of the new episode in an alert operation 20 and the system returns to a waiting mode in the wait operation 15.

In one embodiment, alert operation 20 may include updating a derivative feed on a local or remote computing system to which is copied only the episode identification information that conforms to the filter criteria. The user is alerted to the new episode by the user's device, which has subscribed to derivative feed. In an embodiment, the user's device may be considered separate from the subscription management system. For example, the subscription management system and/or derivative feed may be maintained on a computing device remote from the user's rendering device. The user may access the subscription management system via the user's rendering device or other computing device to transmit the feed and filter criteria selections. In this embodiment, the user is provided the functionality of the subscription management system without the need to change or alter the user's rendering device.

As described above, the derivative feed can be considered a “virtual channel” that contains only episodes conforming to the creator's filter criteria. Such a virtual channel may then be a combined subscription in the sense that it is a single subscription that combines episodes from different feeds. However, it may be considered a separate content in that the episodes in the combined subscription are limited to those episodes that have or discuss a common theme or topic.

A derivative feed may also be made accessible to others, allowing the initial creator to easily distribute episodes with specific content to other consumers with the same interests. In addition, in an embodiment the creator may add the creator's own comments or reviews of each episode in the derivative feed, to provide even more information regarding the creator's virtual channel and its episodes.

In an alternative embodiment, the subscription management system may be included as part of the user's rendering device, such as for example a separate software module that creates a derivative feed on the user's device or a rendering device with podcatching software that includes the subscription management system in a way that non-conforming feeds are ignored by the podcatching software.

As used herein, the terms “episode,” “content”, “media”, or “media files” are used broadly to encompass any product type or category of renderable, experienceable, retrievable, computer-readable filed and/or stored media, either singly or collectively, and individual items of media or content are generally referred to as entries, songs, tracks, pictures, images, items or files, however, the use of any one term is not to be considered limiting as the concepts features and functions described herein are generally intended to apply to any storable and/or retrievable item that may be experienced by a user, whether aurally, visually or otherwise, in any manner now known or to become known. Further, the term content includes all types of media content such as audio and video and products embodying the same.

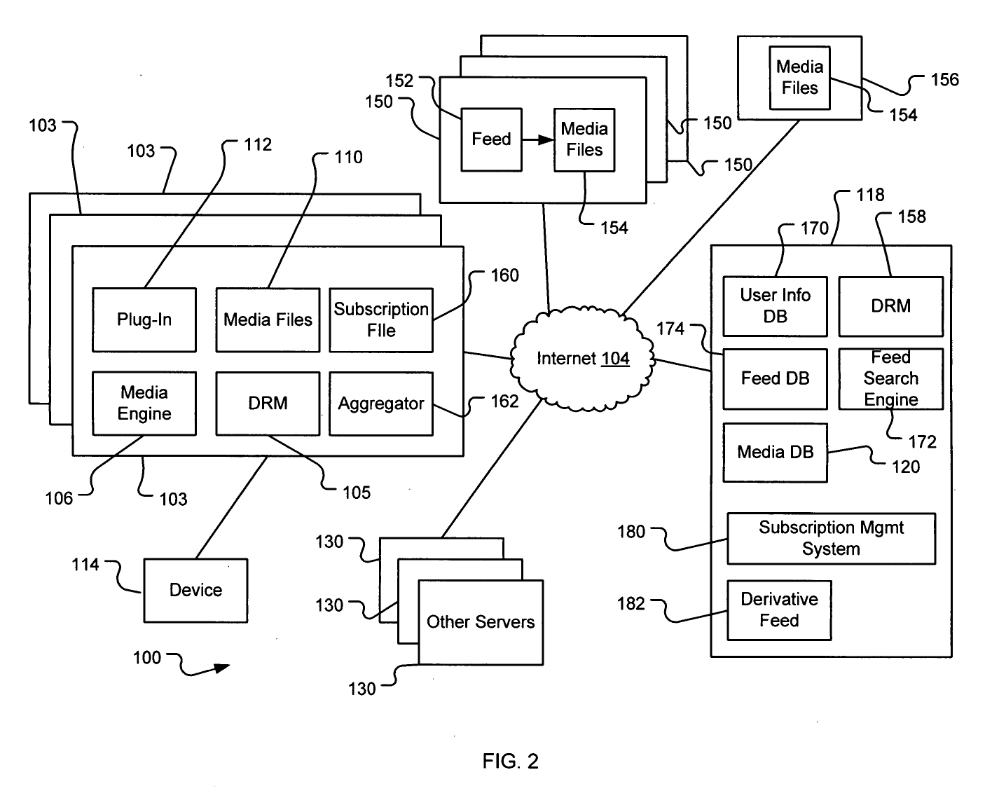

Referring now to FIG. 2, a computing architecture illustrating an embodiment of a subscription management system is shown in schematic form. Although numerous exemplary embodiments will be discussed in terms of music and/or audio files, this invention can also be utilized with any form of audio, video, digital or analog media content, as well as any other media file type now known or to become known.

Each user utilizes a computing device 103 having a computing device, such as personal computer (PC), web enabled cellular telephone, personal digital assistant (PDA) or the like, coupled to a network 104, such as the Internet as shown, by any one of a number of known manners. Furthermore, each computing device 103 preferably includes an Internet browser (not shown), such as that offered by Microsoft Corporation under the trade name INTERNET EXPLORER, or that offered by Netscape Corp. under the trade name NETSCAPE NAVIGATOR, or the software or hardware equivalent of the aforementioned components that enable networked intercommunication between users and service providers and/or among users. Each computing device also includes a media engine 106 that, among other functions to be further described, provides the ability to convert information or data into a perceptible form and manage media related information or data so that user may personalize their experience with various media.

A media engine 106 may be incorporated into computing device 103 by a vendor of computing device 103, or obtained as a separate component from a media engine provider or in some other art recognized manner. As will be further described below, it is contemplated that media engine 106 may be a software application, or a software/firmware combination, or a software/firmware/hardware combination, as a matter of design choice, that serves as a central media manager for a user and facilitates the management of all manner of media files and services that the user might wish to access either through a computer or a personal portable device or through network devices available at various locations via a network. As used herein, the term media file is used generically to refer to an item of media, as well as associated metadata and/or network location information for that item. A computing device 103 may also be referred to as a rendering device 103 to indicate that it is adapted to retrieve and render media files from the network.

Computing device 103 also may include storage of local media files 110 and/or other plug-in programs 112 that are run through or interact with the media engine 106. In one embodiment, media files 110 are audio files. In another embodiment, media files are video files. In yet another embodiment, media files can be a combination file compatible with a MPEG-21 standard or the like. Computing device 103 also may be connectable to one or more portable devices 114 such as a compact disc player and/or other external media file player, commonly referred to as an MP3 player, such as the type sold under the trade name iPod by Apple Computer, Inc., that is used to portably store and play media files.

Local files may be stored on a mass storage device (not shown) that is connected to the computing device 103 or alternatively may be considered part of the computing device 103. The mass storage device and its associated computer-readable media, provide non-volatile storage for the computing device 103. Although the description of computer-readable media contained herein refers to a mass storage device, such as a hard disk or CD-ROM drive, it should be appreciated by those skilled in the art that computer-readable media can be any available media that can be accessed by the computing device 103.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

Additionally, computing device 103 may contain Digital Rights Management software (DRM) 105 that protects the copyrights and other intellectual property rights of the user's media files by enabling secure distribution and/or preventing or hampering illegal distribution of the media files. In one embodiment, DRM 105 encrypts or decrypts the media files for controlled access by authorized users, or alternatively for marking the content with a digital watermark or similar method so that the content can not be freely distributed. Media engine 106 preferably uses the DRM information to ensure that the media files being experienced through media engine 106 are not copied to or shared with users that are unauthorized to listen to or view the content.

The computing device 103 may include the software necessary to subscribe to podcasts. In the embodiment shown, the computing device 103 includes a subscription file 160, such as an OPML file. The subscription file 160 maintains information that identifies what podcasts the user has subscribed to. The subscription file 160 may include a list of feeds 152 and the feed locations.

The computing device 103 also includes a aggregator 162. The aggregator 162 can perform the podcatching functions of an aggregator and can periodically poll the feeds identified in the subscription file 160 to determine if new episodes of the podcast are available. Upon determination that a new episode is available, the aggregator 162 may notify the user or may automatically download the episode to the computing device, such as by retrieving it from a location, such as a media server 150, via the network 104.

In an alternative embodiment, as discussed above with reference to FIG. 1 the computing device 103 may include a subscription management system as a separate module (not shown) or as part of the aggregator 162 or some other module.

The architecture 100 also includes subscription server 118. In addition to serving media over the Internet 104 to the user, subscription server 118 also preferably includes a media database 120, which stores or communicates with storage of various metadata attributes of each particular piece of media. Database 120 may be distributed over multiple servers or locations. Other servers 130 make other content and services available and may provide administrative services such as managing user logon, service access permission, digital rights management, and other services made available through a service provider. Although some of the embodiments of the invention are described in terms of music, embodiments can also encompass any form of streaming or non-streaming media including but not limited to news, entertainment, sports events, web page or perceptible audio or video content. It should be also be understood that although the present invention is described in terms of media content and specifically audio content, the scope of the present invention encompasses any content or media format heretofore or hereafter known.

The subscription server 118 also includes a database 170 of user information. The user information database 170 includes information about users that is collected from users or generated by the subscription server 118 as the user interacts with the subscription server 118. In one embodiment, the user information database 170 includes user information such as user name, gender, e-mail and other addresses, user preferences, etc. that the user may provide to the subscription server 118. In addition, the server 118 may collect information such as what podcasts the user has subscribed to, what searches the user has performed, how the user has rated various podcasts, etc. In effect, any information related to the user and the podcasts that user subscribes to that is available to the subscription server 118 may be stored in the user information database 170.

For example, in one embodiment a user may use the subscription server as a central manager of the user's subscriptions, instead of having multiple devices 103, each subscribed to different feeds. In this embodiment, all subscription information associated with the user is stored in the user information database 170, including the list of feeds that the user is currently subscribed to. This subscription information is updated over time to reflect user actions such as subscribing to new feeds, unsubscribing to feed, and listening to various episodes of feeds.

The user information database 170 may also include information about a user's devices 114. The information allows the subscription server 118 to identify the device and differentiate it from the processor 103. Furthermore, it is anticipated that a single user may have multiple different processors 103 and each processor 103 may be associated with different information. For example, a user may subscribe to a news podcast on a mobile device such as a smart phone 103 or similar Internet connected mobile device 103 and may subscribe to a gaming podcast on a home computer 103. The user information database 170 contains all this information. In one embodiment, the user information database 170 may include the same information contained in the processor's subscription file 160 for each processor 103 associated with the user. The user information database 170 may even include one or more files in the OPML file format for each user.

In the embodiment shown, the subscription server 118 includes a feed database 174. The feed database 174 may include a list of podcasts known to the server 118. This list may be periodically refreshed as the server 118 searches for new feeds 152 and for feeds 152 that have been removed from access to the internet 104. Such a feed database 174 may not be necessary if the searching ability of the server 118 is sufficient to quickly provide user with updated and accurate feed information in response to a user search. The feed database 174 may include all of the information provided by the feed 152. In addition, the feed database 174 may include other information generated by the subscription server 118 or by users. Thus, the feed database 174 may contain information not known to or generated by the publisher of the feed 152.

In an embodiment, the feed database 174 includes additional information regarding feeds 152 in the form of “tags.” A tag is a keyword chosen by a person accessing the subscription server 118 to describe a particular feed 152. The tag can be any word or combination of key strokes. Each tag submitted to the subscription server may be recorded in the feed database 172 and associated with the feed the tag describes. Tags may be associated with a particular feed 152 (e.g., a series tag) or associated with a specific media file 154 within the feed 152 (e.g., an episode tag). Tags will be discussed in greater detail below.

Since tags can be any keyword, a typical name for a category, such as “science” or “business,” may also be used as a tag and in an embodiment the initial tags for a feed are automatically generated by taking the category designations from a feed and using them as the initial tags for the feed. However, note that tags are not a hierarchical category system that one “drills down” through. Tags are not hierarchically related as is required in the typical categorization scheme. Tags are also cumulative in that the number of users that identify a series or an episode with a specific tag are tracked. The relative importance of the specific tag as an accurate description of the associated content (i.e., series or episode) is based on the number of users that associated that tag with the content.

In an embodiment, consumers of feeds 152 are allowed to provide information to be associated with feeds or particular episodes. Thus, the user after consuming data may rate an episode, say on a scale of 1-5 stars, write a review of the episode, and enter tags to be associated with the episode. All this consumer-generated data may be stored in the feed database 174 and associated with the appropriate episode for use in future searches. For example, in an embodiment such community generated information is used as part of the determination operation 18 to determine if an episode conforms to specified filter criteria.

In one embodiment, the search engine 172, discussed below, creates a new entry in the feed database 174 for every feed 152 it finds. Initially, the entry contains some or all of the information provided by the feed 152. An automatic analysis may or may not be performed to match the feed 152 to known tags based on the information provided in the feed 152. For example, in an embodiment some RSS feeds include a category element and the categories listed in that element for the feed are automatically used as the initial tags for the feed. While this is not the intended use of the category element, it is used as an initial tag as a starting point for the generation of more accurate tags for the feed. Note that searches on terms that appear in the feed 152 will return that feed as a result, so it is not necessary to provide tags to a new entry for the search to work properly. Initially no ratings information or user reviews are associated with the new entry. The manager of the subscription server may solicit additional information from the publisher such as the publisher's recommended tags and any additional descriptive information that the publisher wishes to provide but did not provide in the feed 152 itself.

The feed database may also include such information as reviews of the quality of the feeds, including reviews of the series as a whole and reviews specific to each episode in a given feed 152. The review may be a rating such as a “star” rating and may include additional descriptions provided by users.

In addition to maintaining information specific to series and individual episodes within the series, the feed database 174 may also include information associated with publishers of the feeds, sponsors of the feeds, or people in the feeds.

The subscription server 118 includes a feed search engine 172. The feed search engine 172 provides a graphical user interface to users allowing the user to search for and subscribe to feeds 152 using the subscription server 118. The graphical user interface may be an .HTML page served to the processor 103 for display to the user via a browser. Alternatively the graphical user interface may be presented to the user through some other software on the processor 103. An example of a podcast search engine and its graphical user is discussed in commonly assigned U.S. patent application Ser. No. 11/346,777, filed Feb. 2, 2006, which application is hereby incorporated herein by reference. Through the graphical user interface, the feed search engine 172 receives user search criteria. The search engine 172 then uses these parameters to identify feeds 152 that meet the user's criteria. The search may involve an active search of Internet through the use of a web crawler, a search of the feed database 174, or some combination of both 174. The search may include a search of the descriptions provided in the feed 152 of the series and each particular episode in the series. The search may also include a search of the tags and other information associated with feeds 152 listed in the feed database 174, but not provided by the feeds themselves. The results of the search are then displayed to the user via the graphical user interface.

In one embodiment of the present invention, similar to the DRM software 105 located on the user's processor 103, the subscription server may maintain its own DRM software 158 which tracks the digital rights of media files located either in the media database 120 or stored on a user's processor. Thus, for example, before the subscription server 118 streams or serves up or transfers any media files to a user, it validates the rights designation of that particular piece of media and only serves streams or transfers the file if the user has the appropriate rights.

The architecture 100 also includes a number of servers 150 that publish podcasts. That is, the servers 150 include one or more feeds 152, such as RSS feeds, that are accessible through the network, in this case the Internet 104. The feeds 152, as will be described in greater detail below, include information about the feed (e.g., series information) as well as information about the various media files 154 (i.e., episodes) of the feed 152. The feed 152 also identifies the media files 154 so that they can be retrieved by an aggregator on a processor 103. The media file 154 may reside on the podcast server 150 with the feed 152, or may be located on another server 156.

As illustrated in FIG. 2, each user's processor 103, the subscription server 118 and podcast servers 150, as well as the other servers 130, 156 are communicatively connected via the Internet 104. In alternate embodiments, different components of the architecture 100 may be communicatively coupled differently, for example each may be coupled directly to each other wirelessly or by a local or wide area network (WAN) or the like. Additionally, functional components can be distributed so that certain functions of the media engine may be performed at subscription server 118, or vice versa, or distributed in modular fashion for operation at various locations throughout the architecture 100. Thus, the description herein of a function or component being associated with a particular device or component or location is merely exemplary.

The architecture 100 further includes a subscription management system 180. The subscription management system 180 allows a user to determine what future episodes of a feed will be presented to the user. The subscription management system 180 allows a user to select filter criteria that the subscription management system 180 will then use to identify future episodes that are of interest to the user. In addition, the subscription management system 180 also automatically prevents the user from being presented with and possibly downloading future episodes that do not interest the user, thus, saving the user time and effort. In an alternative embodiment, the subscription management system 180 may also limit the episodes that are automatically delivered to the user's device 103, thereby conserving the user's device resources.

In the embodiment shown in FIG. 2, the subscription management system 180 resides on the subscription server 118 and accessed by a user via the internet 104. As discussed above, in an alternative embodiment the subscription management system 180 may reside on the user's computing device 103.

In an embodiment, users interact with the subscription management system 180, such as via graphical user interface as described below, to create one or more profiles or “customized subscriptions.” In an embodiment, subscription management system 180 allows users to name each customized subscription as it is created to differentiate it from other customized subscriptions a user may create. When creating a customized subscription, the user is prompted to select one or more feeds and then select filter criteria for filtering future episodes in the selected feeds. Then, as discussed in FIG. 1, as new episodes are listed in the selected feeds, the episodes are compared to the filter criteria, to determine if they should be presented to the user or not.

As part of the creation process, the subscription management system 180 stores the relevant information including information related to the user creating the customized subscription, the feed or feeds selected, and the filter criteria selected. Any other information provided by the user may also be stored, such as whether the user has indicated a preferred media file type.

The customized subscription information is stored in a data store accessible to the subscription management system 180. For example, in the embodiment shown in FIG. 2, the subscription management system 180 may store the customized subscription information in the user information database 170 and associate it with the user that created the customized subscription. In an alternative embodiment, the subscription management system 180 may store the information in a cookie on the user's computing device or in a separate data store dedicated to holding the customized subscription information.

The subscription management system 180 compares the filter criteria to information known about the episode. Filter criteria may include such descriptive information as keywords, tags, popularity scores or ratings. For example, a filter criterion may be a keyword that appears in the published description of a new episode contained in the feed. A filter criterion may be that the episode meet or exceed a minimum rating score based on ratings received by a ratings system. Tags may also be used as filter criteria such that only episodes tagged with one or more specified tags meet the criteria.

The subscription management system 180 may compare the filter criteria only to the published description of an episode contained in the feed, may compare the filter criteria to other sources of information about the episode, or both. For example, the subscription management system 180 may compare the filter criteria to all the information in the feed database 174 associated with the episode. This may be in addition to comparing the filter criteria to the information in the feed or may be performed instead of comparing the filter criteria to the feed.

The subscription management system 180 allows users to create many different customized subscriptions for different purposes. The customized subscriptions may be limited to a single feed so that the user only gets episodes from that feed regarding a specific topic. In addition, a customized subscription may cover multiple feeds in order to obtain episodes from the selected feeds meeting certain filter criteria via a single subscription. For example, a user may create a “CU Football” customized subscription that filters the user's favorite college football feeds for episodes related to the University of Colorado football program. This prevents the user from having to retrieve and download episodes from multiple feeds in order to find only those episodes relating the user's topic of interest.

In an embodiment, a user subscribes to a customized subscription in the same manner as the user would subscribe to any feed. For example, in one embodiment as part of the creation of the customized subscription the subscription management system generates and transmits information, such as .pcast file for example, to the user's device 103. The information causes or may be used by the user's device to “subscribe” to the customized subscription as if it were a normal feed.

In order to provide customized subscriptions, the subscription management system 180 may, or may not, create an identifiable file structure that corresponds to the customized subscription. In one embodiment, discussed in greater detail below, the subscription management system 180 may create an actual feed, referred to as a derivative feed, to which the user may subscribe. In an alternative embodiment, the subscription management system 180 may not create any identifiable file structure, but rather programmatically generates and delivers information as necessary (such as in response to requests from a user's device) to a user. In this alternative embodiment, the user's device is subscribed to a non-existent feed and requests for updates to the non-existent feed are handled by the subscription management system 180. In either embodiment, there is no difference as far as the user and the user's device are concerned.

In embodiments in which the subscription management system 180 creates a derivative feed 182, the subscription management system 180 may create a derivative feed 182 for each customized subscription created by a user. As the subscription management system 180 identifies new episodes of the selected feeds that conform to the filter criteria, new episode information may be added to the derivative feed 182. Thus, a user simply needs to subscribe to (via the user's aggregator 162) or periodically check (such as via a browser) the derivative feed 182 to obtain access to the episodes of the customized subscription.

In one embodiment, the derivative feed 182 is a podcast feed that contains episode listings of only those episodes that meet the filter criteria selected by the creating user for the customized subscription. For example, for each episode meeting the filter criteria, the subscription management system 180 may copy the complete the episode listing from the episode's feed 152 into the derivative feed 182 and may also copy additional information identifying the feed 152, such as from the feed database. In an alternative embodiment, the derivative feed 182 may include only an identifier, such as a pointer, to an episode listing in another feed 152. The pointer may be automatically interpreted by either the subscription management system 180 or the user's device to retrieve the appropriate episode listing or other information in response to a user request for new episodes in the customized subscription. Alternatively, the derivative feed 182 may consist only of a hyperlink to the episode's media file 154. In yet another embodiment, the derivative feed 182 may include some or all of the episode listing contained in the episode's feed 152.

Another capability of the subscription management system 180 is to create a customized subscription that lists selected episodes which are already on one or more other feeds. This allows a user to create a “virtual channel” of episodes and media files originally and previously published as parts of other feeds or in other contexts. For this, a user creates the customized subscription and uses a graphical user interface to search for and to select episodes from existing feeds. In addition, the user may also select any media file that is accessible, such as via the network 104, to the subscription management system 180. In response to the user's selections, a customized subscription is created that contains only those selected episodes and media files. In an embodiment, a derivative feed 182 is created that contains episode listings for each of the selected episodes and media files.

Customized subscriptions may be maintained as private and may be accessible only to the creator. Alternatively, an embodiment of the subscription management system 180 allows a creator to control public access to any customized subscription and designate each customized subscription created as either private, public (free access by any one) or limited access (access only to a specified group of users, such as paying customers).

Furthermore, the subscription management system 180 may include an access negotiation system in which members of the public may be allowed to purchase access to a customized subscription. In an embodiment, the transaction is managed by the subscription management system 180 and access is provided automatically upon receipt of a real-time payment, such as by an electronic credit card transaction. The access negotiation system in addition to handling automatic purchase may also handle the automatic payment or credit of the creator or owner of the customized subscription.

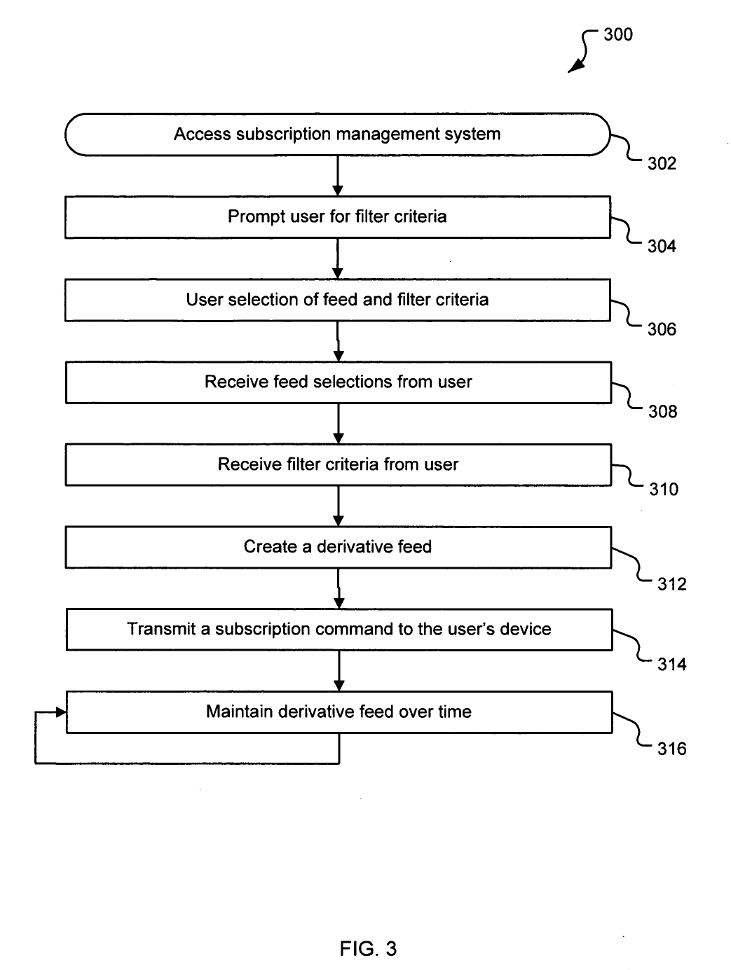

FIG. 3 illustrates an embodiment of a method for subscribing only to episodes of interest to a user. In the embodiment, the user uses a computing device, such as a personal computer or web-enabled portable cell phone, to access a subscription management system in an access operation 302. As discussed above, the subscription management system may be on the user's computing device or located on a remote device, such as a server. If the subscription management system is on a remote server, the user may access the system through use of a browser or a specially adapted client-side front end software module associated with the subscription management system. If the subscription management system is on the user's computing device, the user may access the system by executing it like any other application or may interface with it through some other application, such as via a media player or aggregator application. For example, in an embodiment the subscription management system may be implemented as a plug-in to another software application.

The access operation 302 may include logging in to the subscription management system. For example, if the subscription management system is remote from the user's computing device, logging in identifies the user to the subscription management system and allows the subscription management system to associate the subsequent information with the user and store it appropriately.

The access operation 302 may further include a request from the user to create a customized subscription. Such a request may be received via a graphical user interface (GUI) displayed to the user by the user's computing device (see discussion below). In an embodiment, the GUI may be generated by the subscription management system.

In response to a request, explicit or implicit, to create a customized subscription, the subscription management system prompts the user for filter criteria in a prompt operation 304. The prompt operation 304 may include displaying a filter criteria entry GUI to the user. In an embodiment, such a filter criteria GUI may be generated and transmitted to the user's computing device by the subscription management system, such as in the form of an .HTML page.

In response to the prompt operation 304, the user selects one or more feeds and transmits filter criteria to the subscription management system in a selection operation 306. The selections may be perform by the user entering text into text boxes, making selections from a list or dropdown box or use of a file explorer utility to identify feeds or other files. The filter criteria may consist of any combination of keywords, tags or other criteria such as dates.

Feeds selected by the user in the selection operation 306 may be occasionally referred to herein as “root feeds” in order to distinguish the user selected feed from a derivative feed created by the subscription management system in response to the user's selection. Thus, it should be noted that a derivative feed associated with one user may be a root feed selected by another at a later time to create a second derivative feed.

The selection operation 306 may also include user selection or identification of other attributes related to the customized subscription such as identification of a subscription name, selection of a privacy level for the customized subscription (e.g., private and accessible to the creating user only, limited accessibility to specifically identified users, or publicly accessible), selection of a fee for access to the customized subscription, and selection of such details as what format the user desires episodes to be delivered in, what language is preferred when there is a choice, and whether the user wants episodes automatically downloaded to the user's device.

The selections are transmitted to and received by the subscription management system. In the embodiment shown in FIG. 3, selected feeds are received in a receive feed operation 308 and selected filter criteria are received in a receive filter criteria operation 310. Depending on the embodiment, the receiving operations 308, 310 may be separate operations or may be combined into a single operation (not shown) in which some or all selected information is received by the subscription management system. Receiving may include receiving an HTTP message generated by the user's computing device in response to the user's interaction with a GUI. Alternatively, a different format message or other communication may be received by the subscription management system.

After receiving the selections from the user, the subscription management system then processes the selections to create a customized subscription. In the embodiment shown, processing includes creating a derivative feed and storing the derivative feed at a location on the network in a generate derivative feed operation 312. As described above, the derivative feed may be complete in the sense that it contains the typical static information and links to episodes provided with a normally published feed, or it may include less or more information. In addition, a derivative feed may include embedded commands or logic not normally contained in a feed that perform various functions dynamically, such as retrieving or pointing to static information from the feeds selected by the user or the feed database 174.

The method 300 further includes subscribing the user to the customized subscription in a subscribe operation 314. This may include transmitting a subscribe command, .pcast file or other file to the user's computing device through which the user's computing device is caused to subscribe to the derivative feed. Such a transmission may also include removing a previous subscription from the computing device. In a server embodiment, in which a user uses a server-based system to manage the user's subscriptions such as commonly-assigned U.S. patent application Ser. Nos. 60/750,724 and 11/346,847 titled “Subscription Control Panel” which applications are hereby incorporated herein by reference, the subscribe operation 314 may include saving the selections, the derivative feed location, and other information in a user information database for use when generating the user's subscription list in the future.

After the derivative feed has been created, the derivative feed is maintained by the subscription management system in a maintain customized subscription operation 316. In an embodiment, maintain customized subscription operation 316 includes occasionally inspecting the feed or feeds selected by the user in the selection operation 306, comparing any new episodes with the filter criteria, and revising the derivative feed to include any new episodes that conform or otherwise meet the requirements of the filter criteria. In the embodiment, the inspection may be performed at regular intervals. Alternatively, root feeds may be inspected in response to a notification, such as from the root feed publisher or some other entity, that a new episode has been added or a root feed has been modified. Inspections may also be performed in response to explicit user requests to update the derivative feed.

Other methods of keeping the information in the derivative feed current are also possible and may be utilized in the maintain customized subscription operation 316. For example, in an embodiment maintain customized subscription operation 316 includes an embodiment of a wait operation 15, a new episode determination operation 16, a determination operation 18, and an alert operation 20 as described with reference to FIG. 1, above.

The derivative feed may be maintained indefinitely or until such time as the creator deletes the customized subscription or the customized subscription is otherwise terminated, such as by a user's failure to access the customized subscription for a specified period of time, deactivation of the user's account, or a user's failure to respond to a renewal request for the customized subscription.

The maintain customized subscription operation 316 also includes allowing a user to access and change some or all of the selections made by the user in the selection operation 306. In this way, for example, a user can iteratively adjust the filter criteria, add or remove feeds, or add or remove other users that are permitted to access the customized subscription. Thus, the user retains control over the new episodes delivered via the customized subscription and can modify it over time.

The maintain customized subscription operation 316 also includes allowing a user to provide additional user-generated content to the user's combined subscription. Such user-generated content may take the form of user commentary on the episodes automatically identified by the subscription management system or additional episodes or media files created by the user related to the topic associated with the filter criteria. Such user-generated content may potentially make the customized subscription even more valuable to third party users that may share the creator's interests.

The maintain customized subscription operation 316 may also include updating the derivative feed to reflect changed or evolving perception of episodes. For example, a user may select filter criteria that includes a tags such as “pop” that carries a popular culture connotation. An episode may not initially conform to the filter criteria “pop”, because, for example, it was evaluated before significant community reviews of the episode were available or before the episode became popular and was tagged by the tag “pop”. The maintain customized subscription operation 316 may, as part of the act of looking for new episodes also verify that the evaluation of the previously inspected episodes have not changed. Thus, in an embodiment the contents of a customized subscription may change over time, not because of new episodes being added to feeds, but rather because the perception of old episodes has changed within the community providing description information accessible to the subscription management system.

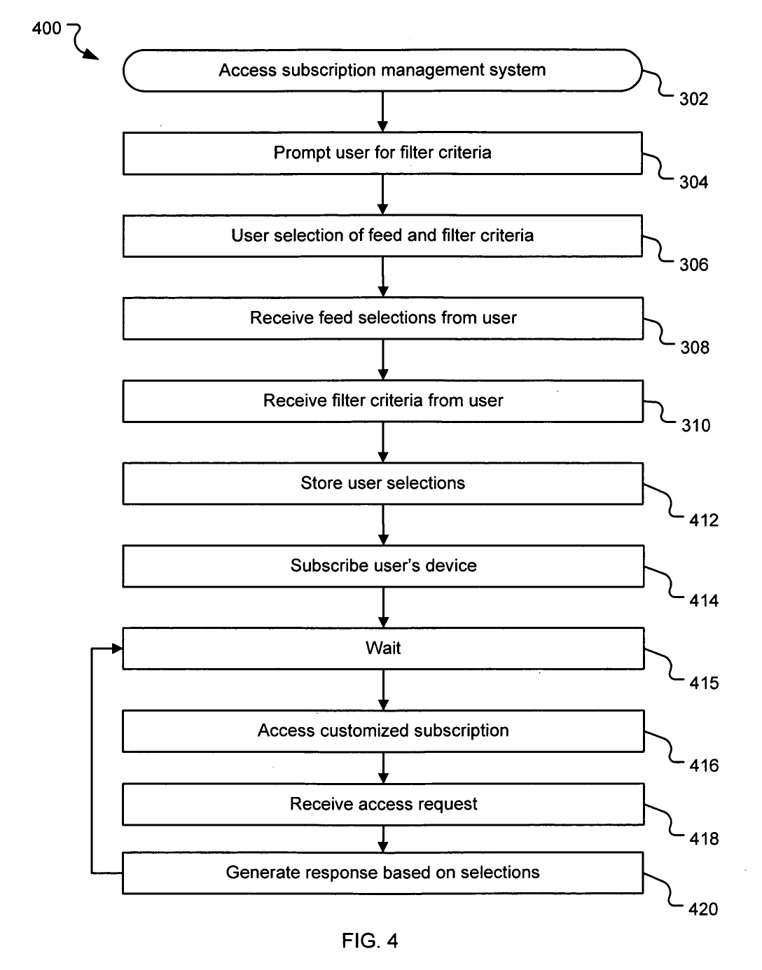

FIG. 4 is an embodiment of a method 400 for subscribing only to episodes of interest to a user that does not utilize a derivative feed. In the method 400, a user may access the subscription management system and select feeds and filter criteria as described with reference to FIG. 3 above. After receiving the selections from the user, the subscription management system then processes the selections to create a customized subscription.

In the method 400, instead or (or in addition to) creating a derivative feed, a store selections operation 412 stores the selections made by the user in a database so that the subscription management system can access the selections at a later time. The information stored may include the selections made by the user, an identifier associated with the user, a record of when the customized subscription was created, and other information generated by the user or the subscription management system related to the customized subscription. For example, the user may select a controlled access feed as a root feed for which a user name and password are required to access the root feed. In the example, the user name and password may be such additional information that the subscription management system stores in order to access the root feed in the future.

As mentioned above, although a derivative feed may not be created a subscribe operation 414 may still performed, as shown in the embodiment in FIG. 4. The subscribe operation 414 differs from that discussed above with reference to FIG. 3 in that there is no actual derivative feed that is subscribed to, rather the user's device may be considered to subscribe to a “virtual feed”. The user's device is provided with a feed identifier that meets the feed identifier requirements of the user's computing device. The feed identifier may be in the form of a URL or other standard identifier of files or feeds on the network. In an embodiment, the computing device then treats the feed identifier as it would an identifier of any other subscribed feed by storing it in a subscription list and using it to generate communications or requests in order to obtain new episodes as part of an feed access operation.

After the storage of the information associated with the customized subscription, the subscription management system then waits for the next user access in a waiting operation 415.

In the embodiment shown, the user's computing device then will occasionally attempt to inspect or otherwise access the customized subscription in an access customized subscription operation 416. In one embodiment of the access customized subscription operation 416, the user's computing device uses the feed identifier to create and transmit a request. However, when the user's computing device attempts to inspect the virtual feed by retrieving or otherwise attempting to access the file identified by the feed identifier, the subscription management system intercepts the communications from the user's computing device in a receive virtual feed access request operation 418.

The subscription management system then dynamically creates a response in a response generation operation 420. The response generation operation 420 may include retrieval of the information associated with the user and the customized subscription. Then, using the retrieved information, the subscription management system may perform a dynamic inspection of the selected root feeds and an identification of new episodes that conform to the user's filter criteria. Based upon the results, the subscription management system then dynamically creates a response that is then transmitted to the user's computing device. The response is tailored to the software on the user's computing device to conform to the expected response format depending on the results of the dynamic inspection. For example, if the user's computing device checks subscribed feeds by downloading the entire feed and checking it against a previous copy or other information stored on the device, then the response generated by the subscription management system is a dynamically generated feed that contains the appropriate information (e.g., new episodes that conform to the filter criteria). However, if the user's computing device checks subscribed feeds by requesting some piece of information such as the date of the last change in the feed, then the response generated by the subscription management system is a dynamically created response that indicates the date of last episode identified that conformed to the user's filter criteria.

There are many other possible ways that a user's computing device may determine if a new episode has been added since the last inspection. However, regardless of the implementation details (such as the number and format of the various communications between the user's device and the subscription management system necessary for the subscription management system to mimic the existence of a feed at the location of the feed identifier), the subscription management system in the response generation operation 420 dynamically generates a response that meets the expectations of the user's computing device and provides the necessary information for the user's computing device to access any new episodes conforming to the filter criteria as if there were an actual derivative feed identified by the feed identifier that contained such new episodes.

In the method 400, after the user's device is provided with all the necessary information to retrieve the new episodes as dictated by the user's device requirements in the response generation operation 420, the subscription management system returns to the waiting operation 415.

Thus, response generation operation 420 may be repeated multiple times until such time as the creator deletes the customized subscription or the customized subscription is otherwise terminated, such as by a user's failure to access the customized subscription for a specified period of time, deactivation of the user's account, or a user's failure to respond to a renewal request for the customized subscription.

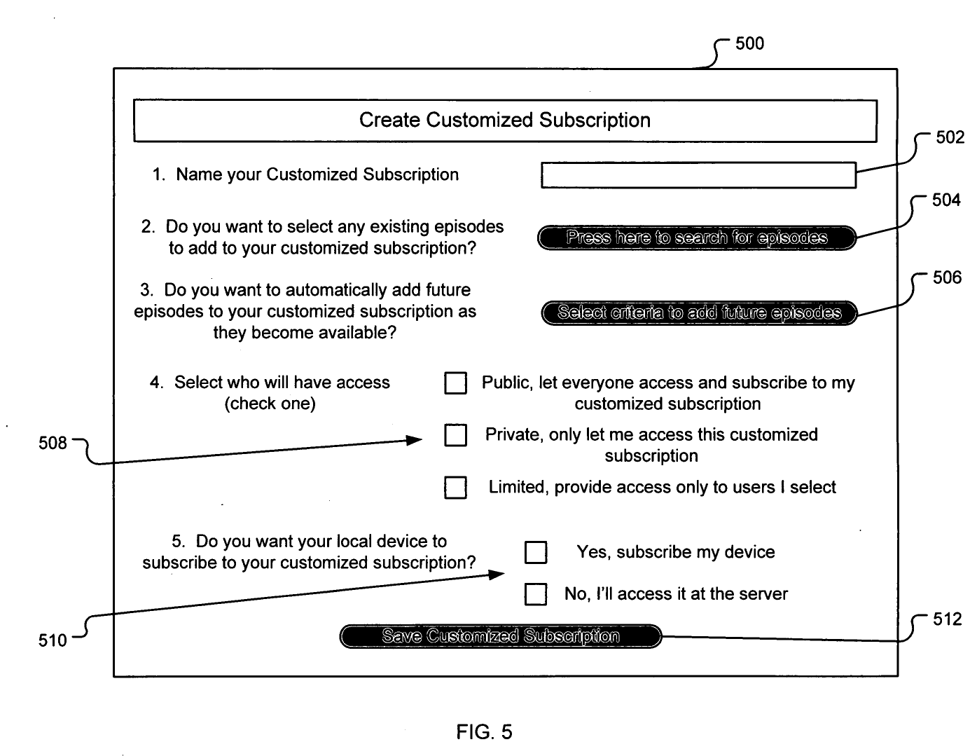

FIG. 5 is an embodiment of a GUI 500 through which a user may create a customized subscription. The GUI 500 includes a number of interface elements that provide information to the user, such as directions and are adapted to receive and transmit information to the subscription management system. For example, interface elements include static elements such as images, graphics and text, data input elements such as text boxes, radio buttons and check boxes, and controls such as user-selectable buttons.

In the embodiment shown, the GUI 500 prompts the user to provide information for the customized subscription. A first text box 502 is provided for the user to name the customized subscription. This name may be incorporated in the feed identifier and/or provided to the user's computing device as the customized subscription name.

A user-selectable control in the form of a button 504 is provided that allows the user to access an episode search engine. In the embodiment, user selection of this button 504 causes an episode search engine GUI (not shown) to be displayed to the user through which the user may select one or more episodes to be initially entered into the new customized subscription. Such functionality allows a user to create a new customized feed that contains episodes that have already been published. In an embodiment, such an episode search engine may also be used to select any media file accessible to the search engine including media files stored on the user's computing device to be included in the customized subscription.

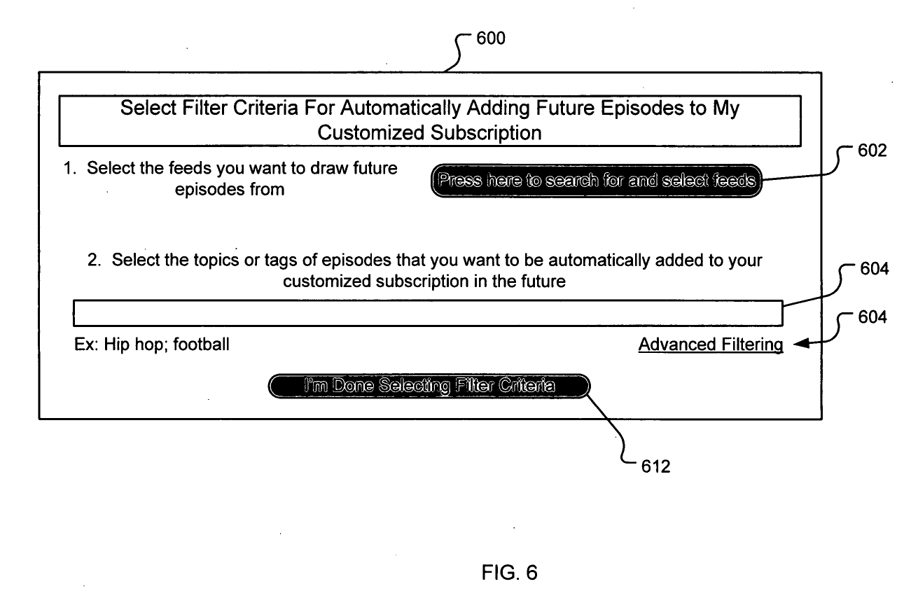

A second user-selectable control is provided in the form of a button 506 for providing filter criteria to the subscription management system. In an embodiment, user selection of the button 506 causes a filter criteria input GUI, such as that discussed with reference to FIG. 6 below, to be displayed to the user through which the user may select filter criteria and feeds.

GUI 500 further includes a set of check box interface elements 508 for identifying the privacy and access attributes of the customized subscription. In the embodiment shown, the user may select one of three check boxes 508 corresponding to a selection of public (i.e., unrestricted access), private, or limited access. Selection of limited access may result in another GUI (not shown) being displayed to the user in which the user is prompted to provide identification information (e.g., e-mail address or user names) for the parties that the creator of the customized subscription wishes to have access to the customized subscription. Alternatively, the user may be prompted to select if the customized subscription is available for a fee to any user who wishes to

GUI 500 further includes a set of check box interface elements 510 through which the user may select to have the user's computing device subscribe to the customized subscription. In the embodiment, the user is also allowed to select that the subscription be maintained at a server remote from the user's computing device, such as through a Subscription Control Panel as described in U.S. patent application Ser. Nos. 60/750,724 and 11/346,847 titled “Subscription Control Panel.”

Finally, in the embodiment shown, a user control in the form of a button 512 is provided that saves the customized subscription. Depending on the embodiment of the method and system used, selection of the button 512 may cause a derivative feed to be created and made accessible at a location on the network, may cause a subscribe command to be transmitted to the user's device, and may cause the information provided by the user through the GUI 500 to be saved in a feed database. Thus, in the embodiment button 512 may be considered to cause the creation of the customized feed.

FIG. 6 is an embodiment of a GUI 600 through which a user may select feeds and filter criteria as part of creating a customized subscription. In the embodiment shown, the GUI 600 includes a user-selectable control in the form of a button 602 for accessing a feed search engine such as that described in U.S. patent application Ser. Nos. 60/722,600 and 11/346,777, titled “Podcast Search Engine” which applications are hereby incorporated herein by reference. Through the feed search engine the user may select one or more feeds as root feeds from which future episodes will be inspected and potentially added to the customized subscription.

The GUI 600 also includes a text box 604 in which the user may enter text to be used as filter criteria. Keywords or phrases entered will be used to determine what new episodes of the root feed selected via the feed search engine will be added to the customized subscription. For example, the user may enter the keyword “football” in order to have episodes described by or containing the word “football” in their description information added to the customized subscription.

n addition, GUI 600 includes a user-selectable link 606 that brings up an advanced filter GUI (not shown). The advance filter GUI allows a user to select and create sophisticated filter criteria such as a keyword appearing only in a specified RSS field of a feed, or exclusionary keyword sets to create rules such provide new episodes concerning the keyword “Mexico” but not “New Mexico,” for instance. Such advanced filter and search criteria selection GUIs are known in the art and suitable for use with embodiments of the system described herein without any further explanation.

Finally, in the embodiment shown, a user control in the form of a button 612 is provided that saves the selected feeds and filter criteria. Depending on the embodiment of the method and system used, selection of the button 612 may return the user to a GUI such as the GUI 500 discussed with reference to FIG. 5 above for completion of the creation of the customized subscription. Alternatively, selection of the button 612 may complete the creation of the customized subscription as discussed above.

Those skilled in the art will recognize that the methods and systems of the present invention within this specification may be implemented in many manners and as such is not to be limited by the foregoing exemplified embodiments and examples. In other words, functional elements being performed by a single or multiple components, in various combinations of hardware and software, and individual functions can be distributed among software applications at either the client or server level. In this regard, any number of the features of the different embodiments described herein may be combined into one single embodiment and alternate embodiments having fewer than or more than all of the features herein described are possible.

For example, the subscription management system may allow a user to subscribe to a customized subscription created by another user for a fee. In the embodiment, the customized subscription system may include a access and billing module through which users may request access to a limited access customized subscription, and automatically be charged for and subscribed to (or otherwise be provided access to) the limited access customized subscription. Such an access and billing module may further automatically pay or credit the creator of the customized subscription so that the entire transaction is handled electronically and without any user intervention other than the initial request.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present invention covers conventionally known and features of those variations and modifications through the system component described herein as would be understood by those skilled in the art.

What is claimed is:

1. A method comprising:
receiving a first request from a user, the first request requesting creation of a customized subscription that contains user-selected episodes from at least one feed;
creating the customized subscription; and
in response to second requests, received after the first request, to access the customized subscription, transmitting information identifying the user-selected episodes from the at least one feed, wherein at least one user-selected episode was not available from the at least one feed when the first request was received.

2. The method of claim 1 further comprising:
receiving a first selection identifying at least one feed, and
receiving a second selection identifying at least one filter criterion that identifies the user-selected episodes.

3. The method of claim 1 wherein creating a customized subscription further comprises:
transmitting a subscribe request to a user's computing device through which the user's computing device subscribes to the customized subscription.

4. The method of claim 1 wherein creating a customized subscription further comprises:
creating a derivative feed; and
copying the derivative to a location on a network.

5. The method of claim 4 wherein creating a customized subscription further comprises:
transmitting a subscribe request to a user's computing device through which the user's computing device subscribes to the derivative feed at the location on the network.

6. The method of claim 4 further comprising:
maintaining the derivative feed over a period of time to reflect changes in the at least one feed during the period of time.

7. The method of claim 6 wherein maintaining further comprises:
performing at least one inspection of the at least one feed during the period of time;
determining that an episode listing associated with an episode has been added to the at least one feed since a previous inspection;
comparing the episode listing to at least one filter criterion;
determining that the episode is a user-selected episode based on the filter criterion and the episode listing; and
copying at least some of the episode listing to the derivative feed.

8. The method of claim 7 wherein comparing further comprises:
retrieving episode information from the at least one feed and from a feed database remote from the at least one feed, the episode information describing the episode identified by the episode listing.

9. The method of claim 7 wherein comparing the episode listing to the at least one filter criterion further comprises:
retrieving the episode listing from the at least one feed;
retrieving review information associated with the episode listing from a database remote from the published feed; and
comparing the retrieved episode listing and retrieved review information to the at least one filter criterion.

10. The method of claim 1 wherein receiving a first request further comprises:
receiving a request to create a customized subscription to user-selected episodes selected from at least two different feeds published at different locations on the network by different publishing entities.

11. The method of claim 1 wherein creating a customized subscription further comprises:
storing information related to the customized subscription and the user in a customized subscription store; and
transmitting to the user a virtual feed identifier for the customized subscription.

12. The method of claim 11 wherein transmitting information further comprises:
dynamically generating the information upon receipt of each second request addressed to the virtual feed identifier.

13. The method of claim 12 wherein dynamically generating further comprises:
determining that a new episode listing associated with a new episode has been added to the at least one feed since a previous second request;
retrieving at a portion of the new episode listing;
comparing the new episode listing to at least one filter criterion;
determining that the new episode is a selected episode based on the filter criterion; and
transmitting at least some of the portion of the new episode listing to the user with the information.

14. The method of claim 1 further comprising:
receiving a third request from a different user to subscribe to the customized subscription; and
charging the different user a fee in return for access to the customized subscription.

15. A method comprising:
receiving a selection of a plurality of first feeds from a user;
receiving a selection of at least one criterion from the user;
receiving a selection of a name to be associated with the plurality of first feeds and the at least one criterion; and
alerting the user of episodes of the plurality of first feeds that meet the at least one criterion, after receiving the selections and as the episodes that meet the at least one criterion become available over a period of time.

16. The method of claim 15 further comprising:
transmitting information to a device of the user's, the information allowing the device to subscribe to a second feed associated with the name;
receiving a request from the device for the second feed; and
transmitting to the device new episode information concerning episodes of the plurality of first feeds that meet the at least one criterion and that have become available since a previous request from the device for the second feed was received.

17. The method of claim 16 further comprising:
creating a feed file corresponding to the second feed;
revising the feed file to identify episodes of the plurality of first feeds that meet the at least one criterion as the episodes become available; and
storing the feed file at a location on a network.

18. The method of claim 17 further comprising:
allowing other users to subscribe to the feed file.

19. The method of claim 17 further comprising:
wherein the feed file is an RSS feed.

20. A system for providing to a user only episodes of feeds of interest to the user comprising:
a subscription management system adapted to receive user selections of at least one feed and at least one filter criteria; and
a customized subscription created by the subscription management system in response to the user selections, the customized subscription when accessed by the user provides information concerning only the episodes of the at least one feed that meet the at least one filter criteria.

21. The system of claim 20 wherein the customized subscription includes a derivative feed stored at a location on a network accessible to the user, the derivative feed containing the information concerning only the episodes of the at least one feed that meet the at least one filter criteria.

22. The system of claim 20 wherein the subscription management system is adapted to transmit subscription information to a user's device in response to receiving the user selections, the subscription information usable by the user's device to subscribe to the customized subscription.

23. The system of claim 22 wherein the subscription information includes a location identifier identifying the location on the network of the derivative feed.

24. The system of claim 22 wherein the subscription information includes a virtual feed identifier and the subscription management system is further adapted to receive requests directed to the virtual feed identifier and dynamically generate the information concerning only the episodes of the at least one feed that meet the at least one filter criteria.

25. The system of claim 20 further comprising:
a feed search engine adapted to identify episodes within feeds that meet the at least one filter criteria and retrieve and deliver the information concerning only the episodes of the at least one feed that meet the at least one filter criteria to the subscription management system.

26. The system of claim 23 wherein the derivative feed is an RSS feed.

27. The system of claim 22 wherein the subscription management system is located on a computing device remote from the user's device.

28. The system of claim 22 wherein the subscription management system is located on the user's device.

29. A graphical user interface for creating a customized subscription comprising:
a first user-selectable interface element for selecting one or more root feeds;
a second interface element for inputting at least one filter criterion for screening episodes of the root feeds;
a third interface element for inputting a name of the customized subscription; and
a fourth interface element that, upon selection by a user, causes the customized subscription to be created, the customized subscription containing one or more episodes of the one or more root feeds that conform to the at least one filter criterion.

30. The graphical user interface of claim 29 further comprising:
one or more fifth interface elements through which the user selects an access attribute for the customized subscription.

31. The graphical user interface of claim 29 further comprising:
one or more sixth interface elements allowing through which the user may cause a subscription request to be transmitted to a user's device, the subscription request including information allowing the user's device to subscribe to the customized subscription.

32. The graphical user interface of claim 29 further comprising:
a seventh interface element for receiving text, the text received by the seventh interface element being stored and subsequently used as filter criteria in screening of episodes of the root feeds.
